(19) United States
(12) Patent Application Publication
(10) Pub. No.: US 2025/0389275 A1
(43) Pub. Date: Dec. 25, 2025

(54) BLOWER WITH IMPROVED PERFORMANCE USING POWER

(71) Applicant: Milwaukee Electric Tool Corporation, Brookfield, WI (US)

(72) Inventors: Caleb Robert Hendryx, Waukesha, WI (US); Beau Alexander Harrier, Brown Deer, WI (US); Andrew T. Medeiros-Nicholson, Cedarburg, WI (US); Patrick Dennis Gallagher, New Berlin, WI (US); Robert K. Paddock, Waukesha, WI (US)

(21) Appl. No.: 19/246,908

(22) Filed: Jun. 24, 2025

Related U.S. Application Data
(60) Provisional application No. 63/663,279, filed on Jun. 24, 2024.

(51) Int. Cl. F04D 27/00; A01G 20/47

(52) U.S. Cl. CPC F04D 27/004; A01G 20/47

(57) ABSTRACT

A blower is provided. The blower includes a main body; an air duct extending between an air inlet and an air outlet opposite the air inlet, the air duct including an air duct body; a motor for driving a fan disposed in the air duct body between the air inlet and the air outlet; and a controller disposed in the main body and electrically coupled to the motor for controlling a power output of the motor. The controller is configured to receive a power setpoint, operate in a first mode based on the power setpoint being less than or equal to a power threshold, and operate in a second mode based on the power setpoint being greater than the power threshold.

### CROSS-REFERENCE TO RELATED APPLICATIONS

This application is a non-provisional application claiming the benefit of priority under 35 U.S.C. § 119(e) to U.S. Provisional Application No. 63/663,279, filed on Jun. 24, 2024, which is hereby incorporated by reference in its entirety.

### FIELD

The present disclosure relates generally to blowers, and more particularly to blowers having improved performance using power.

### BACKGROUND

Blowers are generally used to produce and output a stream of air to be directed by the user. Blowers are frequently utilized in outdoor applications, such as to blow leaves and other debris. Homeowners frequently utilized such blowers to clean their yards and outdoor spaces. The types of blowers can vary between backpack-style blowers and handheld blowers, as well as between gas-powered and electric blowers. Electric blowers can be corded and plugged into electrical outlets, or can be cordless and battery powered.

Environmental conditions, such as pressure, humidity, and temperature, may negatively impact the performance of blowers. For example, the environmental conditions may reduce the output and runtime of a blower. Accordingly, improved blowers are desired in the art. In particular, blowers which provide a constant output and consistent runtime would be advantageous.

### BRIEF DESCRIPTION

Aspects and advantages of the present disclosure will be set forth in part in the following description, or may be obvious from the description, or may be learned through practice of the technology.

In accordance with one embodiment, a blower is provided. The blower includes a main body; an air duct extending between an air inlet and an air outlet opposite the air inlet, the air duct including an air duct body; a motor for driving a fan disposed in the air duct body between the air inlet and the air outlet; and a controller disposed in the main body and electrically coupled to the motor for controlling a power output of the motor. The controller is configured to receive a power setpoint, operate in a first mode based on the power setpoint being less than or equal to a power threshold, and operate in a second mode based on the power setpoint being greater than the power threshold.

In accordance with another embodiment, a method of controlling a motor of a blower is provided. The method includes receiving a power setpoint; operating in a first mode based on the power setpoint being less than or equal to a power threshold, wherein operating in the first mode includes performing a first plurality of operations. The first plurality of operations includes receiving a rotational speed setpoint of a fan of the motor, receiving a measured rotational speed of the fan of the motor, comparing the rotational speed setpoint to the measured rotational speed to obtain a speed difference, and adjusting a rotational speed of the fan of the motor based on the speed difference obtained. The method also includes operating in a second mode based on the power setpoint being greater than the power threshold, wherein operating in the second mode includes performing a second plurality of operations. The second plurality of operations include receiving a measured power, comparing the measured power to the power setpoint to obtain a power difference, generating a control signal based on the power difference, and adjusting a power output of the motor based on the control signal.

In accordance with yet another embodiment, a method of controlling a motor of a blower is provided. The method includes receiving a power setpoint; comparing the power setpoint to a plurality of power ranges; obtaining an assigned power range based on the power setpoint being within one of the plurality of power ranges; and operating the motor such that a power output of the motor is within the assigned power range.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a blower in accordance with embodiments of the present disclosure;

FIG. 2 is a schematic diagram of a control module in accordance with embodiments of the present disclosure;

FIG. 3 is a flow chart of a method of operating a blower in accordance with embodiments of the present disclosure;

FIG. 4 is a schematic diagram of a control module in accordance with embodiments of the present disclosure; and

FIG. 5 is a block diagram of an example of a computing system in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, environmental conditions, such as pressure, humidity, and temperature, may negatively impact performance of a blower. For example, blower output and blower runtime may be reduced. However, operating the motor of a blower at a constant power output, such as by using a power control module, can ensure that the output of the blower remains constant and the runtime of the blower is consistent despite such environmental conditions.

Referring now to the drawings, FIG. 1 illustrates a blower tool 10 having a main body 12 and a blower unit 14. While the blower tool 10 illustrated in FIG. 1 is a backpack blower configured to be worn on a user's back, e.g., with backpack supports 16, the features of the present invention may be implemented for a handheld blower (not illustrated), e.g., a handheld axial fan blower or a centrifugal fan blower. A motor and a fan (not shown) may be disposed within the main body 12 or the blower unit 14. Additionally, a power source 13 may be removably coupled to the blower tool 10 and configured to supply power to the motor. For example, the power source 13 may include one or more batteries removably coupled to a portion of the blower tool 10. In other example embodiments, the blower tool 10 may include a corded electric power source and/or a gas power source.

In at least one example embodiment, the blower unit 14 includes an air duct 20 extending from an air inlet 22 to an air outlet 24. The air duct 20 may be formed by an air duct body 26 and a blower tube 28. For example, the air duct body 26 may define the air inlet 22 at one end thereof. The air duct body 26 may be coupled, directly or indirectly, with the blower tube 28 at an opposite end relative to the air inlet 22. For example, an elbow tube 35 may be provided between the air duct body 26 and the blower tube 28 as shown in FIG. 1. Alternatively, e.g., in a handheld blower (not shown), the air duct body 26 may be directly coupled to the blower tube 28. In some example embodiments, a bellows 40 may be provided between the air duct body 26 and the blower tube 28, e.g., to enable the blower tube 28 to pivotably move and/or rotate relative to the air duct body 26.

In at least one example embodiment, the blower tool 10 includes a controller 100 for controlling operation of the blower tool 10 by activating and deactivating the motor and/or the fan. The controller 100 may be disposed in the blower unit 14, as shown in FIG. 1. In other example embodiments, the controller 100 may be disposed in the main body 12.

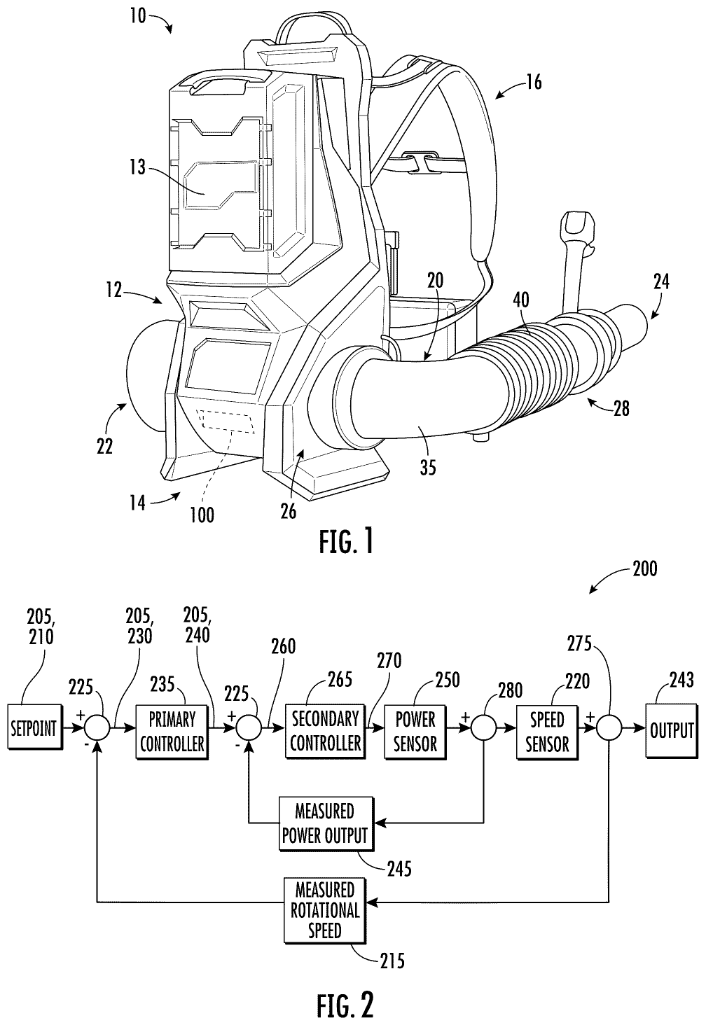

FIG. 2 is a schematic diagram of a control module 200 in accordance with embodiments of the present disclosure.

In at least one example embodiment, the controller 100 includes the control module 200. The control module 200 is configured to maintain a constant power output by the motor of the blower tool 10. The control module 200 receives a setpoint by an operator of the blower tool. More specifically, the control module 200 may receive one or both of a power setpoint 205 and a rotational speed setpoint 210. The power setpoint 205 may be a desired power output set by the operator of the blower tool 10. The rotational speed setpoint 210 may be a desired rotational speed of the fan set by the operator or a rotational speed of the fan of the motor required to achieve the desired power output set by the operator.

In at least one example embodiment, the control module 200 is configured to operate in a first mode based on the power setpoint 205 being less than or equal to a power threshold and a second mode based on the power setpoint 205 being greater than the power threshold.

The control module 200 includes a primary controller 235 for controlling the rotational speed of the fan of the motor of the blower tool 10 in the first mode. The control module 200 is configured to receive the power setpoint 205 and a measured rotational speed 215 from the fan of the motor. For example, the control module 200 may include a speed sensor 220 for measuring the rotational speed of the fan.

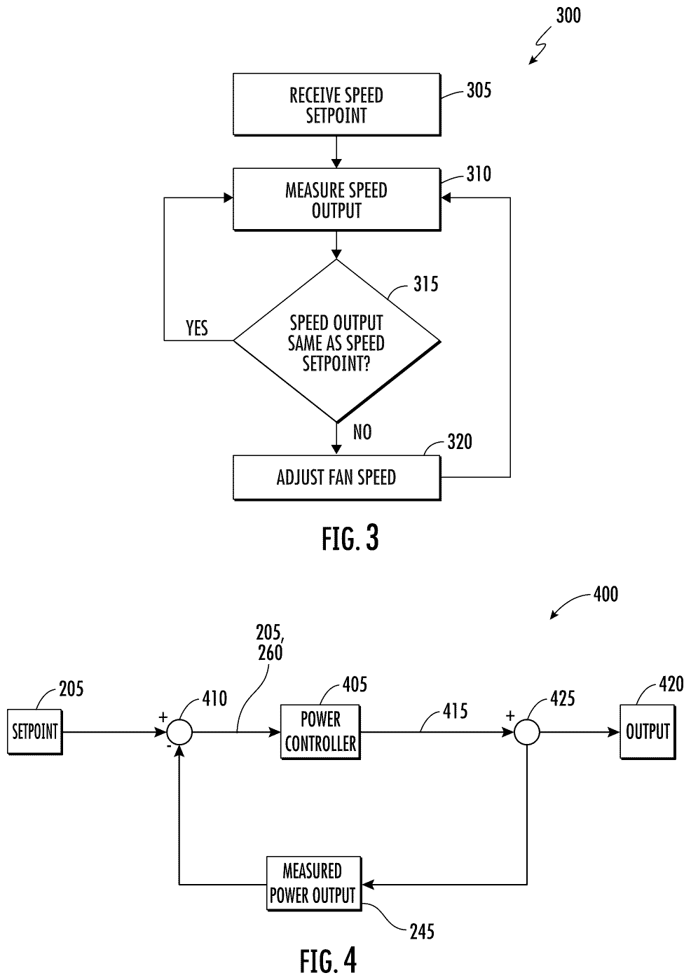

The control module 200 also includes a first summation module 225 configured to receive the rotational speed setpoint 210 and the measured rotational speed 215. The first summation module 225 obtains a speed difference 230 between the rotational speed setpoint 210 and the measured rotational speed 215. The speed difference 230 is supplied to the primary controller 235. The primary controller 235 may generate a speed control signal 240 based on the speed difference 230. For example, if there is no difference between the rotational speed setpoint 210 and the measured rotational speed 215, such as when the speed difference 230 is about 0, the current operation of the blower tool 10 may be maintained. However, if there is a difference between the rotational speed setpoint 210 and the measured rotational speed 215, the operation of the blower tool 10 may be adjusted, such as by adjusting the rotational speed of the fan of the motor, and thereby the power output of the motor, as will be discussed below with respect to FIG. 3.

Moreover, in the first mode, the speed control signal 240 may be output to the motor of the blower tool 10 at 243. The speed control signal 240 may instruct the motor to adjust the rotational speed of the fan of the motor to control the power output of the motor. For example, the speed control signal 240 may cause the rotational speed of the fan to increase if the measured rotational speed 215 is less than the rotational speed setpoint 210 or the speed control signal 240 may cause the rotational speed of the fan to decrease if the measured rotational speed 215 is greater than the rotational speed setpoint 210.

In the first mode, the control module 200 of the controller 100 may continuously compare the rotational speed setpoint 210 and the measured rotational speed 215 to maintain a constant power output by the motor. More specifically, the control module 200 continues to operate in the first mode as long as the power setpoint 205 remains less than or equal to the power threshold. For example, if the power setpoint 205 is less than or equal to the power threshold at 275, the measured rotational speed 215 is provided to the first summation module 225, such as from the speed sensor 220. Moreover, while the power output by the motor may remain constant, the rotational speed of the fan may fluctuate (increase or decrease) to maintain the constant power output.

As discussed above, if the power setpoint 205 is greater than the power threshold, the control module 200 operates in the second mode. In the second mode, the control module 200 is configured to receive a measured power output 245 from the motor. For example, the motor may include a power sensor 250 for measuring the output of the motor. The power setpoint 205 and the measured power output 245 are provided to a second summation module 255. The second summation module 255 obtains a power difference 260 between the power setpoint 205 and the measured power output 245. The power difference 260 is supplied to the secondary controller 265. The secondary controller 265 may generate a power control signal 270 based on the power difference 260. For example, if there is no difference between the power setpoint 205 and the measured power output 245, such as when the power difference 260 is about 0, the current operation of the blower tool 10 may be maintained. However, if there is a difference between the power setpoint 205 and the measured power output 245, the operation of the blower tool 10 may be adjusted. For example, a voltage output of the motor may be adjusted based on the power control signal 270 in order to adjust the power output of the motor. Moreover, in the second mode mode, the power control signal 270 may be output to the motor of the blower tool 10 at 243.

Still referring to FIG. 2, the control module 200 of the controller 100 may continuously compare the power setpoint 205 to the measured power output 245 to maintain a constant power output by the motor of the blower tool 10. More specifically, the control module 200 continues to operate in the second mode as long as the power setpoint 205 is greater than the power threshold. For example, if the power setpoint 205 remains greater than the power threshold at 280, the measured power output 245 is provided to the second summation module 255, such as from the power sensor 250. Accordingly, the control module 200 may continuously compare the power setpoint 205 to the power threshold to determine whether to operate in the first mode or the second mode to maintain a constant power output by the motor.

FIG. 3 is a flow chart of a method 300 of operating a blower in accordance with embodiments of the present disclosure. More specifically, the first operating mode discussed above with respect to FIG. 2 includes the method 300 of operating the blower tool 10.

In at least one example embodiment, the method 300 includes receiving a speed setpoint at 305, measuring a speed output at 310, determining whether the measured speed output is the same as the speed setpoint at 315, and adjusting the fan speed at 320 if the measured speed output is not the same as the speed setpoint at 315. One or more portions of the method 300 may be implemented by one or more computing devices, such as the controller 100.

In at least one example embodiment, receiving the speed setpoint at 305 includes receiving a desired speed set by the operator. Measuring the speed output at 310 includes measuring a rotational speed of the fan of the motor. For example, a sensor, such as the speed sensor 220 (FIG. 2), may be disposed within the blower unit 14 for measuring the rotational speed of the fan of the motor.

In at least one example embodiment, determining whether the speed output is the same as the speed setpoint at 315 includes determining whether there is a difference between the measured speed output and the speed setpoint. If there is no difference, such as when the measured speed output is the same as the speed setpoint, the method 300 may return to measuring the speed output at 310. For example, the rotational speed of the fan of the motor is continuously monitored. If there is a difference between the measured speed output and the speed setpoint, the fan speed may be adjusted at step 320.

In at least one example embodiment, adjusting the fan speed at 320 includes sending a control signal from the controller 100 to the motor. The control signal may instruct the motor to increase the rotational speed of the fan if the measured speed output is less than the speed setpoint or decrease the rotational speed of the fan if the measured speed output is greater than the speed setpoint.

In at least one example embodiment, the method 300 returns to measuring the speed output at 310 after adjusting the fan speed at 320. In this manner, the controller 100 continuously monitors the rotational speed of the fan in the first mode of operation (discussed with respect to FIG. 2) to ensure the rotational speed of the fan of the motor is maintained at the speed setpoint.

FIG. 4 is a schematic diagram of a control module 400 in accordance with embodiments of the present disclosure.

In at least one example embodiment, the controller 100 includes the control module 400. The control module 400 is configured to maintain a constant power output by the motor of the blower tool 10. The control module 400 may be similar or analogous to the control module 200 discussed above with respect to FIG. 2. For example, the control module 400 receives a setpoint by an operator of the blower tool. More specifically, the control module 400 may receive the power setpoint 205.

The control module 400 is also configured to receive the measured power output 245 from the motor. For example, the control module 400 may include a sensor, such as the power sensor 250 discussed with respect to FIG. 2, for measuring the output of the motor. The power setpoint 205 and the measured power output 245 are provided to a summation module 410. The summation module 410 obtains the power difference 260 between the power setpoint 205 and the measured power output 245. The power setpoint 205 and the power difference 260 is supplied to a power controller 405.

In at least one example embodiment, the control module 400 is configured to operate in a plurality of operating modes. More specifically, the power controller 405 maps the power setpoint 205 to one of the plurality of operating modes. Each of the plurality of operating modes includes a power range for operating the motor. For example, the control module 400 may operate in a first operating mode including a first power range and at least a second operating mode including a second power range different from the first power range. Accordingly, the power controller 405 is configured to determine the operating mode, and thus the power range, based on the power setpoint 205.

In at least one example embodiment, the power controller 405 is configured to obtain an assigned power range based on the power setpoint 205. For example, if the power setpoint 305 is within the first operating range, the assigned power range is the first operating range. Alternatively, if the power setpoint 205 is within the second power range, the assigned power range is the second operating range.

The power controller 405 may generate a power control signal 415 based on the assigned power range. The power control signal 415 may be output to the motor of the blower tool 10 at 420. The power control signal 415 may instruct the motor to adjust the rotational speed of the fan of the motor such that the power output of the motor is within the assigned power range. Additionally, or alternatively, a voltage output of the motor may be adjusted based on the power control signal 415 such that the power output of the motor is within the assigned power range.

The control module 400 of the controller 100 may continuously monitor the power setpoint 205 and compare the power setpoint 205 to the power ranges of the plurality of operating modes. For example, if the power setpoint 205 remains within the assigned power range at 425, the measured power output 245 is continuously supplied to the summation module 410 such that the power controller 405 may continuously adjust the power output of the motor of the blower tool 10 based on the power difference 260, if necessary. If the power setpoint 205 is not within the assigned power range at 425, such that an operator may have adjusted the desired power output, the power controller 405 obtains a new assigned power range based on the power setpoint 205 and operates the motor such that the power output is within the new assigned power range. Accordingly, the control module 400 may continuously monitor the power setpoint 205 and the measured power output 245 to maintain a constant power output by the motor.

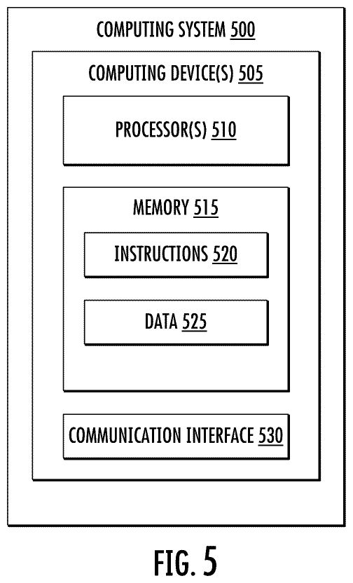

FIG. 5 is a block diagram of an example of a computing system 500 in accordance with embodiments of the present disclosure.

In at least one example embodiment, the computing system 500 can include one or more computing device(s) 505. For example, the one or more computing device(s) 505 may include at least one of the controller 100. Each of the one or more computing device(s) 505 may include one or more processor(s) 510 and one or more memory device(s) 515. The one or more processor(s) 510 can include any suitable processing device, such as a microprocessor, microcontroller, integrated circuit, logic device, or other suitable processing device. The one or more memory device(s) 515 can include one or more computer-readable media, including, but not limited to, non-transitory computer-readable media, RAM, ROM, hard drives, flash drives, or other memory devices.

The one or more memory device(s) 515 can store information accessible by the one or more processor(s) 510, including computer-readable instructions 520 that can be executed by the one or more processor(s) 510. The instructions 520 can be any set of instructions that when executed by the one or more processor(s) 510, cause the one or more processor(s) 510 to perform operations. The instructions 520 can be software written in any suitable programming language or can be implemented in hardware. In some embodiments, the instructions 520 can be executed by the one or more processor(s) 510 to cause the one or more processor(s) 510 to perform operations, such as the operations for generating performing implement and other scans to determine tracking indicia in accordance with processing stages of processing cycle utilizing a plurality of cutting implements, generate state data and association data associated with cutting implements, detect missing cutting implements, and initiate control actions associated with missing control elements as described above, and/or any other operations or functions of the one or more computing device(s) 505.

The memory device(s) 515 can further store data 525 that can be accessed by the one or more processor(s) 510. For example, the data 525 can include state data, association data, processing cycle and/or stages data, and user interface data, etc., as described herein. The data 525 can include one or more table(s), function(s), algorithm(s), model(s), equation(s), etc. according to example embodiments of the present disclosure.

The one or more computing device(s) 505 can also include a communication interface 530 used to communicate, for example, with the other components of system. The communication interface 530 can include any suitable components for interfacing with one or more network(s), including for example, transmitters, receivers, ports, controllers, antennas, or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Further aspects of the disclosure are provided by one or more of the following embodiments:

A blower includes a main body; an air duct extending between an air inlet and an air outlet opposite the air inlet, the air duct including an air duct body; a motor for driving a fan disposed in the air duct body between the air inlet and the air outlet; and a controller disposed in the main body and electrically coupled to the motor for controlling a power output of the motor. The controller is configured to receive a power setpoint, operate in a first mode based on the power setpoint being less than or equal to a power threshold, and operate in a second mode based on the power setpoint being greater than the power threshold.

The blower of any one or more embodiments, wherein the controller is further configured to perform a first plurality of operations in the first mode, the first plurality of operations comprising receiving a rotational speed setpoint of the fan of the motor; receiving a measured rotational speed of the fan of the motor; comparing the rotational speed setpoint to the measured rotational speed to obtain a speed difference; and adjusting a rotational speed of the fan of the motor based on the speed difference obtained.

The blower of any one or more embodiments, wherein the controller is further configured to perform a second plurality of operations in the second mode, the second plurality of operations comprising: receiving a measured power; comparing the measured power to the power setpoint to obtain a power difference; generating a control signal based on the power difference; and adjusting the power output of the motor based on the control signal.

The blower of any one or more embodiments, wherein the adjusting the power output of the motor includes adjusting a voltage output of the motor based on the control signal.

The blower of any one or more embodiments, wherein the adjusting the power output of the motor includes adjusting a rotational speed of the fan.

The blower of any one or more embodiments, wherein adjusting the rotational speed of the fan comprises: increasing the rotational speed of the fan if the measured power is less than the power setpoint; and decreasing the rotational speed of the fan if the measured power is greater than the power setpoint.

The blower of any one or more embodiments, wherein: the controller is configured to operate in a plurality of operating modes, the plurality of operating modes including the first mode and the second mode; and each of the plurality of operating modes include a power range.

The blower of any one or more embodiments, wherein the first mode includes a first power range and the second mode includes a second power range different from the first power range.

The blower of any one or more embodiments, wherein the controller is further configured to: obtain an assigned power range based on the power setpoint being within the power range of one of the plurality of operating modes; receive a measured power output; compare the measured power output to the assigned power range; and operate the motor such that the power output is within the assigned power range.

The blower of any one or more embodiments, wherein the controller is configured to maintain a constant power output.

A method of controlling a motor of a blower, including receiving a power setpoint; operating in a first mode based on the power setpoint being less than or equal to a power threshold, wherein operating in the first mode includes performing a first plurality of operations. The first plurality of operations includes receiving a rotational speed setpoint of a fan of the motor, receiving a measured rotational speed of the fan of the motor, comparing the rotational speed setpoint to the measured rotational speed to obtain a speed difference, and adjusting a rotational speed of the fan of the motor based on the speed difference obtained. The method also includes operating in a second mode based on the power setpoint being greater than the power threshold, wherein operating in the second mode includes performing a second plurality of operations. The second plurality of operations include receiving a measured power, comparing the measured power to the power setpoint to obtain a power difference, generating a control signal based on the power difference, and adjusting a power output of the motor based on the control signal.

The method of any one or more embodiments, wherein the adjusting the power output of the motor includes adjusting a voltage output of the motor based on the control signal.

The method of any one or more embodiments, wherein the adjusting the power output of the motor includes adjusting a rotational speed of the fan.

The method of any one or more embodiments, wherein adjusting the rotational speed of the fan comprises increasing the rotational speed of the fan if the measured power is less than the power setpoint; and decreasing the rotational speed of the fan if the measured power is greater than the power setpoint.

A method of operating a motor of a blower includes receiving a power setpoint; comparing the power setpoint to a plurality of power ranges; obtaining an assigned power range based on the power setpoint being within one of the plurality of power ranges; and operating the motor such that a power output of the motor is within the assigned power range.

The method of any one or more embodiments, wherein the operating the motor comprises: operating the motor in a first operating mode based on the power setpoint being within a first power range of the plurality of power ranges; and operating the motor in a second operating mode based on the power setpoint being within a second power range of the plurality of power ranges.

The method of any one or more embodiments, wherein the second power range is different than the first power range.

The method of any one or more embodiments, further comprising: receiving a measured power output; comparing the measured power output to the assigned power range; and operating the motor such that the power output of the motor is within the assigned power range.

The method of any one or more embodiments, wherein the operating the motor such that the power output of the motor is within the assigned power range comprises adjusting a rotational speed of a fan of the motor.

The method of any one or more embodiments, wherein the operating the motor such that the power output of the motor is within the assigned power range comprises adjusting a voltage output of the motor.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A blower, comprising:
a main body;
an air duct extending between an air inlet and an air outlet opposite the air inlet, the air duct including an air duct body;
a motor for driving a fan disposed in the air duct body between the air inlet and the air outlet; and
a controller disposed in the main body and electrically coupled to the motor for controlling a power output of the motor, the controller configured to:
receive a power setpoint,
operate in a first mode based on the power setpoint being less than or equal to a power threshold, and
operate in a second mode based on the power setpoint being greater than the power threshold.

2. The blower of claim 1, wherein the controller is further configured to perform a first plurality of operations in the first mode, the first plurality of operations comprising:
receiving a rotational speed setpoint of the fan of the motor;
receiving a measured rotational speed of the fan of the motor;
comparing the rotational speed setpoint to the measured rotational speed to obtain a speed difference; and
adjusting a rotational speed of the fan of the motor based on the speed difference obtained.

3. The blower of claim 1, wherein the controller is further configured to perform a second plurality of operations in the second mode, the second plurality of operations comprising:
receiving a measured power;
comparing the measured power to the power setpoint to obtain a power difference;
generating a control signal based on the power difference; and
adjusting the power output of the motor based on the control signal.

4. The blower of claim 3, wherein the adjusting the power output of the motor includes adjusting a voltage output of the motor based on the control signal.

5. The blower of claim 3, wherein the adjusting the power output of the motor includes adjusting a rotational speed of the fan.

6. The blower of claim 5, wherein adjusting the rotational speed of the fan comprises:
increasing the rotational speed of the fan if the measured power is less than the power setpoint; and
decreasing the rotational speed of the fan if the measured power is greater than the power setpoint.

7. The blower of claim 1, wherein:
the controller is configured to operate in a plurality of operating modes, the plurality of operating modes including the first mode and the second mode; and
each of the plurality of operating modes include a power range.

8. The blower of claim 7, wherein the first mode includes a first power range and the second mode includes a second power range different from the first power range.

9. The blower of claim 7, wherein the controller is further configured to:
obtain an assigned power range based on the power setpoint being within the power range of one of the plurality of operating modes;
receive a measured power output;
compare the measured power output to the assigned power range; and
operate the motor such that the power output is within the assigned power range.

10. The blower of claim 1, wherein the controller is configured to maintain a constant power output.

11. A method of controlling a motor of a blower, comprising:
receiving a power setpoint;
operating in a first mode based on the power setpoint being less than or equal to a power threshold, wherein operating in the first mode includes performing a first plurality of operations, the first plurality of operations comprising:
receiving a rotational speed setpoint of a fan of the motor,
receiving a measured rotational speed of the fan of the motor,
comparing the rotational speed setpoint to the measured rotational speed to obtain a speed difference, and
adjusting a rotational speed of the fan of the motor based on the speed difference obtained; and
operating in a second mode based on the power setpoint being greater than the power threshold, wherein operating in the second mode includes performing a second plurality of operations, the second plurality of operations comprising:
receiving a measured power,
comparing the measured power to the power setpoint to obtain a power difference,
generating a control signal based on the power difference, and
adjusting a power output of the motor based on the control signal.

12. The method of claim 11, wherein the adjusting the power output of the motor includes adjusting a voltage output of the motor based on the control signal.

13. The method of claim 11, wherein the adjusting the power output of the motor includes adjusting a rotational speed of the fan.

14. The method of claim 13, wherein adjusting the rotational speed of the fan comprises:
increasing the rotational speed of the fan if the measured power is less than the power setpoint; and
decreasing the rotational speed of the fan if the measured power is greater than the power setpoint.

15. A method of operating a motor of a blower, comprising:
receiving a power setpoint;
comparing the power setpoint to a plurality of power ranges;
obtaining an assigned power range based on the power setpoint being within one of the plurality of power ranges; and
operating the motor such that a power output of the motor is within the assigned power range.

16. The method of claim 15, wherein the operating the motor comprises:
operating the motor in a first operating mode based on the power setpoint being within a first power range of the plurality of power ranges; and
operating the motor in a second operating mode based on the power setpoint being within a second power range of the plurality of power ranges.

17. The method of claim 16, wherein the second power range is different than the first power range.

18. The method of claim 15, further comprising:
receiving a measured power output;
comparing the measured power output to the assigned power range; and
operating the motor such that the power output of the motor is within the assigned power range.

19. The method of claim 18, wherein the operating the motor such that the power output of the motor is within the assigned power range comprises adjusting a rotational speed of a fan of the motor.

20. The method of claim 18, wherein the operating the motor such that the power output of the motor is within the assigned power range comprises adjusting a voltage output of the motor.
